(19) United States
(12) Patent Application Publication
(10) Pub. No.: US 2026/0219993 A1
(43) Pub. Date: Jul. 30, 2026

(54) System and Method for Managing Online Recovery in Log Structured Metadata

(71) Applicant: Dell Products L.P., Round Rock, TX (US)

(72) Inventors: Weibing Zhang, Beijing (CN); Lei Gao, Beijing (CN); Chen Gong, Beijing (CN); Huan Chen, Beijing (CN); Vamsi K. Vankamamidi, Hopkinton, MA (US); Samuel L. Mullis, II, Raleigh, NC (US)

(21) Appl. No.: 19/041,262

(22) Filed: Jan. 30, 2025

(51) Int. Cl. G06F 11/14

(52) U.S. Cl. CPC G06F 11/1451; G06F 11/1466; G06F 11/1469; G06F 2201/80; G06F 2201/84

(57) ABSTRACT

A method, computer program product, and computing system for processing a plurality of IO requests on a storage system. A plurality of metadata pages associated with the processing of the plurality of IO requests are generated. A snapshot of the plurality of metadata pages is generated. A plurality of actions on the snapshot are performed without interfering with subsequent IO requests processed on the storage system.

### BACKGROUND

Storing and safeguarding electronic content may be beneficial in modern business and elsewhere. Accordingly, various methodologies may be employed to protect and distribute such electronic content.

For example, storage systems increasingly use log structured metadata (LSM) to track metadata updates and perform recovery actions. LSM provides a logical address space to replace the physical layout for all metadata (MD) pages. With LSM, the association between the address space and the physical space will be maintained by LSM mapping and is indirect. LSM manages the physical layout and lifecycle of metadata pages and is a bridge to connect the metadata logical address space to the physical locations. One of the major issues facing recovery on storage systems is the need to take the system offline in order to run exhaustive detection and corrective actions. This is primarily due to the dynamic and rapidly changing nature of the storage system's metadata while it is online and serving customer IO requests. Synchronizing recovery actions while the system is online presents significant challenges to the ability to bring the entirety of the system's metadata into self-consistency. For example, garbage collection and other background actions performed on LSM are halted to ensure that the recovery action has a consistent representation of the metadata pages.

### SUMMARY OF DISCLOSURE

In one example implementation, a computer-implemented method executed on a computing device may include, but is not limited to, processing a plurality of IO requests on a storage system. A plurality of metadata pages associated with the processing of the plurality of IO requests are generated. A snapshot of the plurality of metadata pages is generated. A plurality of actions on the snapshot are performed without interfering with subsequent IO requests processed on the storage system.

One or more of the following example features may be included. Generating the plurality of metadata pages may include storing the plurality of metadata pages in a metadata tier. Generating the snapshot of the plurality of metadata pages may include pausing changes to the metadata tier while the snapshot is generated. Performing the plurality of actions on the snapshot may include performing online recovery of the metadata tier using the snapshot of the plurality of metadata pages. An amount of free space in the metadata tier may be determined. An action may be performed on the metadata tier based upon, at least in part, the amount of free space in the metadata tier and a predefined free space threshold. Performing the action on the metadata tier may include, in response to determining that the amount of free space in the metadata tier is below the predefined free space threshold, identifying a target metadata page for the action that is on the metadata tier and has a corresponding metadata page on the snapshot; and updating the corresponding metadata page on the snapshot using the metadata page from the metadata tier. Performing the action on the metadata tier may include, in response to determining that the amount of free space in the metadata tier is above the predefined free space threshold, pausing the action on the metadata tier.

In another example implementation, a computer program product resides on a computer readable medium that has a plurality of instructions stored on it. When executed by a processor, the instructions cause the processor to perform operations that may include, but are not limited to, processing a plurality of IO requests on a storage system. A plurality of metadata pages associated with the processing of the plurality of IO requests are generated. A snapshot of the plurality of metadata pages is generated. A plurality of actions on the snapshot are performed without interfering with subsequent IO requests processed on the storage system.

One or more of the following example features may be included. Generating the plurality of metadata pages may include storing the plurality of metadata pages in a metadata tier. Generating the snapshot of the plurality of metadata pages may include pausing changes to the metadata tier while the snapshot is generated. Performing the plurality of actions on the snapshot may include performing online recovery of the metadata tier using the snapshot of the plurality of metadata pages. An amount of free space in the metadata tier may be determined. An action may be performed on the metadata tier based upon, at least in part, the amount of free space in the metadata tier and a predefined free space threshold. Performing the action on the metadata tier may include, in response to determining that the amount of free space in the metadata tier is below the predefined free space threshold, identifying a target metadata page for the action that is on the metadata tier and has a corresponding metadata page on the snapshot; and updating the corresponding metadata page on the snapshot using the metadata page from the metadata tier. Performing the action on the metadata tier may include, in response to determining that the amount of free space in the metadata tier is above the predefined free space threshold, pausing the action on the metadata tier.

In another example implementation, a computing system includes at least one processor and at least one memory architecture coupled with the at least one processor, wherein the at least one processor is configured to process a plurality of IO requests on a storage system. A plurality of metadata pages associated with the processing of the plurality of IO requests are generated. A snapshot of the plurality of metadata pages is generated. A plurality of actions on the snapshot are performed without interfering with subsequent IO requests processed on the storage system.

One or more of the following example features may be included. Generating the plurality of metadata pages may include storing the plurality of metadata pages in a metadata tier. Generating the snapshot of the plurality of metadata pages may include pausing changes to the metadata tier while the snapshot is generated. Performing the plurality of actions on the snapshot may include performing online recovery of the metadata tier using the snapshot of the plurality of metadata pages. An amount of free space in the metadata tier may be determined. An action may be performed on the metadata tier based upon, at least in part, the amount of free space in the metadata tier and a predefined free space threshold. Performing the action on the metadata tier may include, in response to determining that the amount of free space in the metadata tier is below the predefined free space threshold, identifying a target metadata page for the action that is on the metadata tier and has a corresponding metadata page on the snapshot; and updating the corresponding metadata page on the snapshot using the metadata page from the metadata tier. Performing the action on the metadata tier may include, in response to determining that the amount of free space in the metadata tier is above the predefined free space threshold, pausing the action on the metadata tier.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and an online recovery process coupled to a distributed computing network according to one or more example implementations of the disclosure;

FIG. 2 is an example diagrammatic view of the storage system of FIG. 1 according to one or more example implementations of the disclosure;

FIG. 3 is an example diagrammatic view of a metadata architecture of the storage system of FIG. 1 according to one or more example implementations of the disclosure;

FIG. 4 is an example flowchart of the online recovery process of FIG. 1 according to one or more example implementations of the disclosure; and

FIG. 5 is an example diagrammatic view of the online recovery process of FIG. 1 according to one or more example implementations of the disclosure.

Like reference symbols in the various drawings indicate like elements.

### DETAILED DESCRIPTION

### System Overview

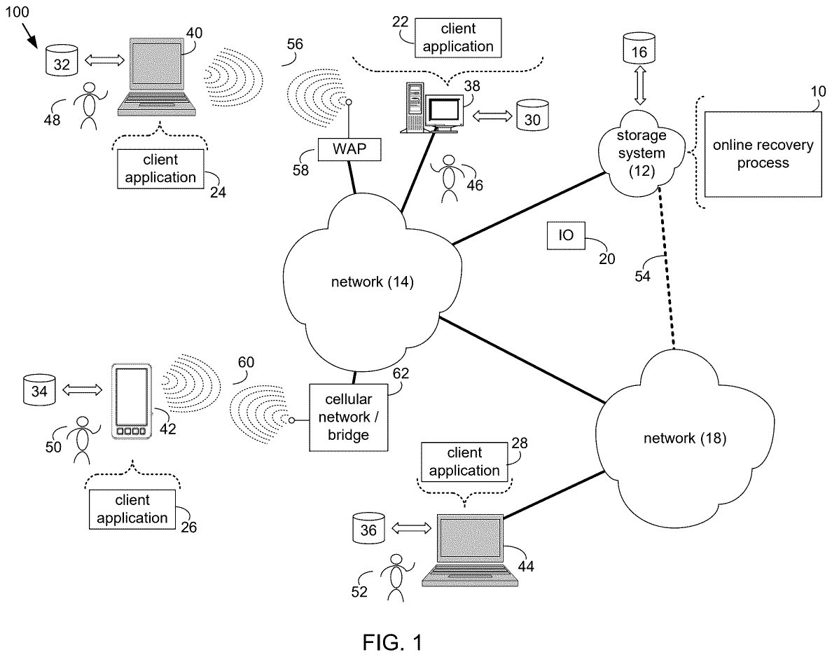

Referring to FIG. 1, there is shown online recovery process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of online recovery process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of online recovery process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an online recovery process, such as online recovery process 10 of FIG. 1, may include but is not limited to, processing a plurality of IO requests on a storage system. A plurality of metadata pages associated with the processing of the plurality of IO requests are generated. A snapshot of the plurality of metadata pages is generated. A plurality of actions on the snapshot are performed without interfering with subsequent IO requests processed on the storage system.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

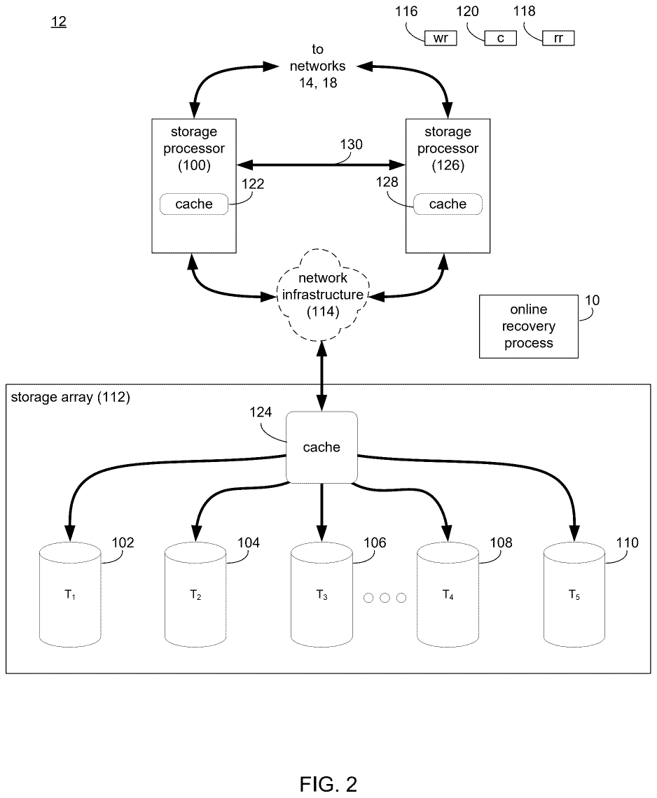

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form storage array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of online recovery process 10. The instruction sets and subroutines of online recovery process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of online recovery process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to storage array 112 (if frontend cache memory system 122 is configured as a write-through cache) or may subsequently write content 118 to storage array 112 (if frontend cache memory system 122 is configured as a write-back cache).

Storage array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of storage array 112, content 118 to be written to storage array 112 may be received from storage processor 100. Storage array 112 may initially store content 118 within backend cache memory system 124 prior to being stored on e.g., one or more of storage targets 102, 104, 106, 108, and coded target 110.

As discussed above, the instruction sets and subroutines of online recovery process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of online recovery process 10 may be executed by one or more processors (not shown) and one or more memory architectures (not shown) included within storage array 112.

Further and as discussed above, during the operation of storage array 112, content (e.g., content 118) to be written to storage array 112 may be received from storage processor 100 and initially stored within backend cache memory system 124 prior to being stored on e.g., one or more of storage targets 102, 104, 106, 108, 110. Accordingly, during use of storage array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to storage array 112 (if frontend cache memory system 128 is configured as a write-through cache) or may subsequently write content 118 to storage array 112 (if frontend cache memory system 128 is configured as a write-back cache).

In some implementations, the instruction sets and subroutines of online recovery process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of online recovery process 10 may be executed by one or more processors (not shown) and one or more memory architectures (not shown) included within storage array 112.

Further and as discussed above, during the operation of storage array 112, content (e.g., content 118) to be written to storage array 112 may be received from storage processor 126 and initially stored within backend cache memory system 124 prior to being stored on e.g., one or more of storage targets 102, 104, 106, 108, 110. Accordingly, during use of storage array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### Metadata Architecture

In the context of storage systems, metadata may generally include useful internal information managed by a storage array to describe and locate user data. All modern arrays abstract the physical media and present logical (virtualized) addresses to clients in the form of Logical Unit Numbers (LUNs) (i.e., a unique identifier for a storage partition in a SAN). The mapping between the logical address and physical address is a form of metadata that the array needs to manage. That is typically the most common form of metadata for SAN storage systems. Newer architectures manage additional metadata to implement additional capabilities. For example, snapshots, change tracking for efficient remote replication, deduplication pointers, and compression all involve managing some form of metadata.

The classic metadata structure of traditional storage systems directly links a Logical Address of a block to the physical location of the block. In this metadata structure, every logical block written, has a physical block linked directly to it. In addition, as most traditional storage systems were architected for a spinning disk storage medium optimized for sequential writes the address of the logical address affects the physical location that the data is stored. This can lead to an unbalanced storage array that can suffer from hot-spots as specific address space ranges may experience more performance/input-output operations per second (IOPs) than other address space ranges.

Embodiments of the present disclosure may support a flash/random access medium. For example, embodiments of the present disclosure may include a metadata structure that completely decouples the Logical Block Address space address from the physical one. This is done by leveraging a multi-layer architecture.

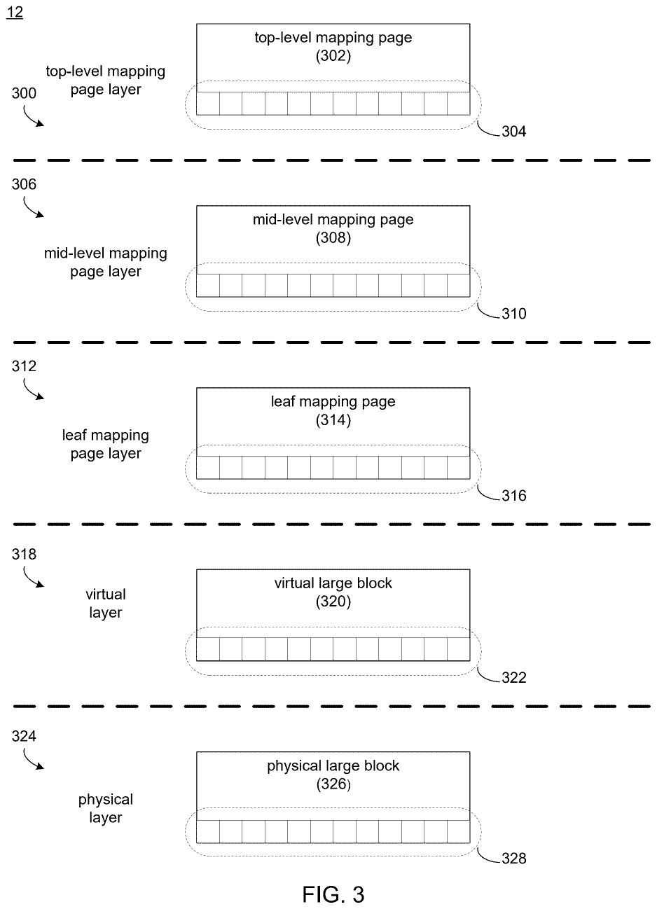

Referring also to FIG. 3, a storage system may generally include a mapper layer which is structured as a file system with various layers of pages and blocks. In some implementations, the combination of various metadata layers mapper layers may be referred to as a mapper metadata tree. While the following example includes metadata “blocks”, it will be appreciated that other units of data storage may be used within the scope of the present disclosure. In some implementations, a top-level mapping page layer (e.g., top-level mapping page layer 300) may include top-level mapping page pages (e.g., top-level mapping page 302) with a plurality of entries (e.g., plurality of entries 304) that map or point to a plurality of entries of one or more mid-level mapping pages. A mid-level mapping page layer (e.g., mid-level mapping page layer 306) may include mid-level mapping page pages (e.g., mid-level mapping page 308) with a plurality of entries (e.g., plurality of entries 310) that map or point to a plurality of entries of one or more leaf mapping pages. A leaf mapping page layer (e.g., leaf mapping page layer 312) may include leaf mapping page pages (e.g., leaf mapping page 314) with a plurality of entries (e.g., plurality of entries 316) that map or point to a plurality of entries of one or more virtual large blocks. Leaf mapping page layer 312 may represent various ranges of Logical Block Addresses (LBAs). For example, each entry of the plurality of entries (e.g., plurality of entries 316) of the leaf mapping page (e.g., leaf mapping page 314) may be associated with an LBA range. In some implementations, the combination of top-level mapping page layer 300, mid-level mapping page layer 306, and leaf mapping page layer 312 may be organized in a “tree” data structure where each leaf mapping page is a “leaf” of the “tree” data structure that corresponds to a specific LBA range. Accordingly, each leaf mapping page (e.g., leaf mapping page 314) may hold a mapping of a LBA to a virtual large block. It will be appreciated that other data structures may be used within the scope of the present disclosure to organize the first layer.

In some implementations, a virtual layer (e.g., second layer 318) may include virtual large blocks (e.g., virtual large block 320) with a plurality of entries (e.g., plurality of entries 322) that map to a plurality of entries of one or more physical large blocks. The virtual layer (e.g., virtual layer 318) may generally isolate the logical address of a block from the physical location of the block. For example, a virtual large block (e.g., virtual large block 308) may encapsulate the physical location of user data and allow relocation without updating leaf mapping pages (e.g., leaf mapping page 314). Accordingly, the virtual layer (e.g., virtual layer 318) may decouple the Logical Block Address space address from the physical one. In some implementations, virtual large blocks (e.g., virtual large block 320) are also referred to as “virtual layer pages” within the scope of the present disclosure.

In some implementations, a physical layer (e.g., physical layer 324) may include physical large blocks (e.g., physical large block 326) with a plurality of entries or portions (e.g., plurality of entries 328) that are configured to store user data. In this manner, physical layer 324 may describe the physical location of user data in a storage system. In some implementations, each physical large block (e.g., physical large block 326) may have a predefined amount of storage capacity for storing data (e.g., user data). In some implementations, physical large blocks (e.g., physical large block 326) are also referred to as “user data pages” within the scope of the present disclosure.

### The Online Recovery Process

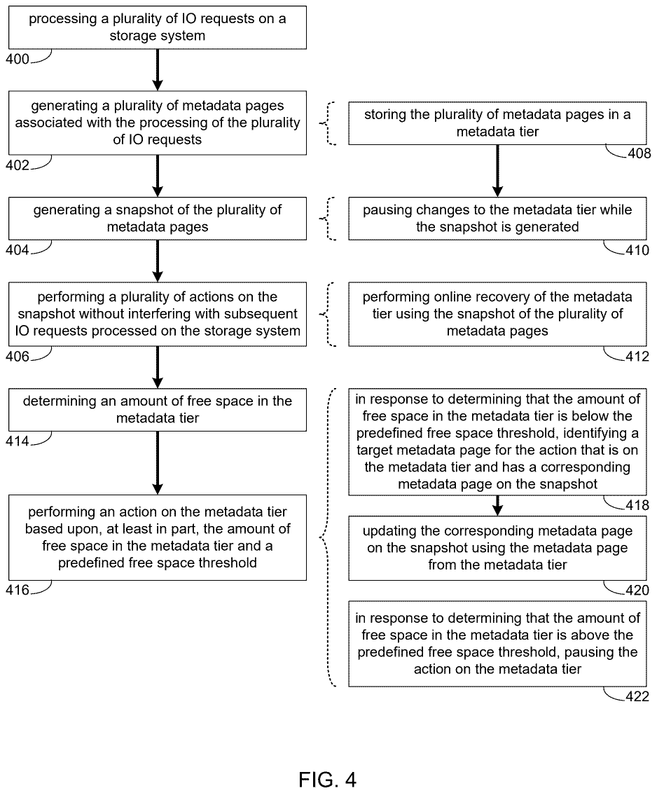

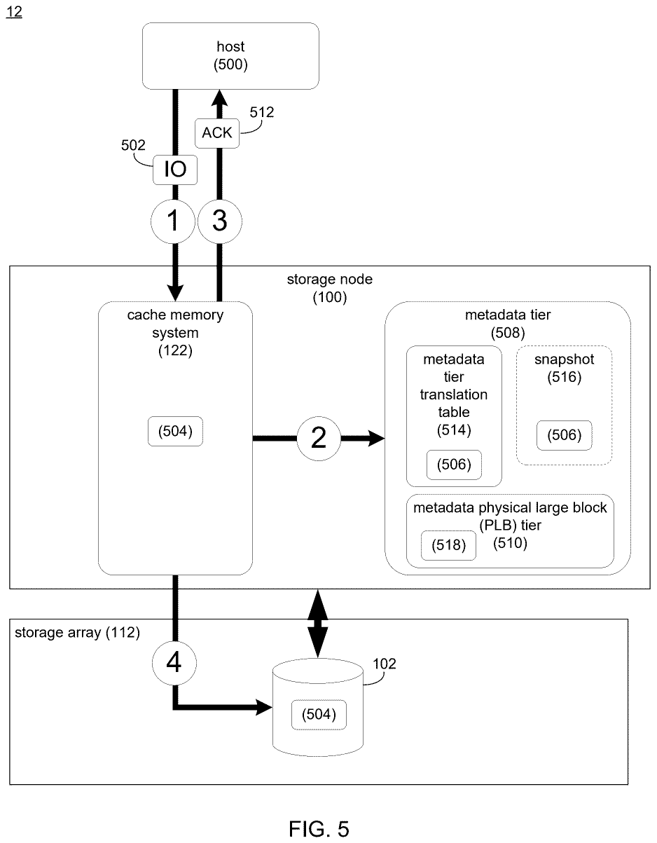

Referring also to FIGS. 4-5 and in some implementations, online recovery process 10 processes 400 a plurality of IO requests on a storage system. A plurality of metadata pages associated with the processing of the plurality of IO requests are generated 402. A snapshot of the plurality of metadata pages is generated 404. A plurality of actions on the snapshot are performed 406 without interfering with subsequent IO requests processed on the storage system.

Implementations of the present disclosure allow storage system operations, such as metadata recovery, which require exclusive access to the storage system's metadata, to occur while the storage system otherwise remains online. For example, online recovery process 10 utilizes log structured metadata (LSM) to track metadata updates and performs recovery actions against a time-based snapshot of said metadata. Online recovery process 10 generates a snapshot of the metadata, performs actions against that snapshot, and ensures that background operations do not interfere with the execution of the action. Specifically, when garbage collection (GC) attempts to reclaim space in the metadata tier, the operation will proceed with the knowledge that recovery (or another action) is in progress on the snapshot and reclaim over those metadata pages will be prevented while references to pages moved as part of the garbage collection process will be updated in a coordinated fashion with the online recovery. Accordingly, online recovery process 10 allows online recovery to work with LSM by generating a static copy of the LSM metadata tier and prevents interruptions from user IO and background services when online recovery is running against the static metadata copy.

In some implementations, online recovery process 10 processes 400 a plurality of IO requests on a storage system. For example and referring also to FIG. 5, suppose a host (e.g., host 500) sends an IO request (e.g., IO request 502) to write data to a storage array (e.g., storage array 112) using a storage node (e.g., storage node 100). In this example, online recovery process 10 may write the data (e.g., user data page 504) to the cache memory system (e.g., cache memory system 122) of the processing storage node (e.g., storage node 100). This is shown as action “1” in FIG. 5.

In some implementations, online recovery process 10 generates 402 a plurality of metadata pages associated with the processing of the plurality of IO requests. A metadata page (e.g., metadata page 506) may generally include a reference or pointer to a user data page that includes a logical address of the user data page. The metadata page may also include a sequence transaction number that tracks the order of write operations. Additionally, the metadata page may include other types of information.

In some implementations, generating 402 the plurality of metadata pages includes storing 408 the plurality of metadata pages in a metadata tier (e.g., metadata tier 508). A metadata tier (e.g., metadata tier 508) includes a data structure that stores metadata pages associated with user data pages in cache memory system 122 and/or storage array 112. In some implementations, the metadata page may be utilized to recover data during a restart or storage system failure. For example, metadata pages may be used to determine the order of user data pages to apply to recover a storage system. In some implementations, the metadata tier includes a metadata tier translation table (i.e., a data structure for storing the metadata architecture as described above and as shown in FIG. 3). For example and as will be described in greater detail below, when restoring user data pages may include processing the metadata pages from the metadata tier translation table during a recovery operation to recover the state of the storage system at the time of the failure or shutdown of storage system 12.

In some implementations, once a metadata page corresponding to a user data page is stored in the log memory system, the content and order of a user data pages may be recovered during a storage system failure or restart. In one example, online recovery process 10 stores user data page 504 in a metadata physical large block (PLB) tier (e.g., metadata PLB tier 510) within metadata tier 508. Referring again to FIG. 5, online recovery process 10 may send an acknowledgment signal (e.g., ACK 512) to the host device (e.g., host device 400) once the data (e.g., user data page 504) is persisted in non-volatile memory (e.g., metadata PLB tier 510). Specifically, once the metadata page (e.g., metadata page 506) is stored in the metadata tier translation table (e.g., metadata tier translation table 514), user data page 504 is persisted both physically (i.e., in metadata PLB tier 510) and logically (i.e., in metadata tier translation table 514). This is shown as “3” in FIG. 5.

In some implementations, online recovery process 10 may write 302 at least a portion of the plurality of user data pages from the cache memory system. For example, at some point in time after writing the data to the cache memory system and log memory system, data may be “flushed” or written from the cache memory system to the persistent memory of the storage array. Flushing a page buffer may include flushing a user data page-metadata page pair. For example, when the user data page-metadata page pair is written, the data of the user data page may be written (from the cache memory system) to the persistent memory of the storage system while the metadata page may be retained.

Referring again to FIG. 5 and at some point in time after writing the data (e.g., user data page 504) to cache memory system 122 and metadata tier 508, user data page 504 may be “flushed” or written from cache memory system 122 to the persistent memory of the storage array (e.g., storage array 112). User data page 404 may be invalidated in cache memory system 122 during the flushing. This is shown as “4” in FIG. 5. In response to invalidating the user data page from the cache memory system, online recovery process 10 may free the user data page back to the metadata PLB tier (e.g., metadata PLB tier 510). For example, freeing the user data page may include releasing the space occupied by the user data page for writing and storing new data associated with a new IO write operation. In some implementations and in response to freeing the user data page, online recovery process 10 may mark the user data page (e.g., user data page 504) as flushed. In this manner, the user data page may be marked as flushed for a read IO request.

In some implementations, online recovery process 10 generates 404 a snapshot of the plurality of metadata pages. A snapshot of the plurality of metadata pages is a copy of the metadata pages at the time the snapshot is requested. In one example, online recovery process 10 generates a snapshot by copying the metadata pages in metadata tier 508. For LSM-enabled storage system 12, online recovery process 10 generates 404 a snapshot (e.g., snapshot 516) of metadata tier translation table 514 for running online recovery.

In some implementations, generating 404 the snapshot of the plurality of metadata pages includes pausing 410 changes to the metadata tier while the snapshot is generated. For example, while generating 404 snapshot 516, new metadata changes to LSM from other operations are paused 410 by online recovery process 10 in order to obtain a consistent snapshot of current metadata tier translation table 514.

In some implementations, online recovery process 10 performs 406 a plurality of actions on the snapshot without interfering with subsequent IO requests processed on the storage system. As metadata address space and physical space are indirectly mapped, any metadata addressing is processed through LSM. For online recovery that performs metadata health checking and updating, online recovery process 10 performs metadata analysis on top of LSM. Using snapshot 516, various actions can be performed on the snapshot without interfering with the processing of subsequent IO requests that result in changes to the metadata tier translation table.

In some implementations, performing 406 the plurality of actions on the snapshot includes performing 412 online recovery of the metadata tier using the snapshot of the plurality of metadata pages. In one example, online recovery process 10 performs 412 online recovery of metadata tier 508 using snapshot 516. During online recovery, online recovery process 10 reads each metadata page from snapshot 516 of metadata tier translation table 514 to restore user data pages that are not persisted to storage array 112. In this example, the active metadata tier translation table continues serving new metadata changes to LSM in parallel with the online recovery. Accordingly, subsequent IO operations and other actions performed using metadata tier translation table 514 are not interrupted by the online recovery.

In some implementations, online recovery process 10 coordinates background operations, specifically garbage collection, with online recovery and other operations. For example, subsequent IO actions, garbage collection, and other operations or actions can be performed by storage system 12 that result in changes to metadata pages in metadata tier translation table 514 while online recovery is performed 412 using snapshot 516. In one example, online recovery process 10 synchronizes background operation metadata changes with the snapshot metadata where such synchronization is required.

In some implementations, online recovery process 10 coordinates metadata changes between snapshot 516 during online recovery and metadata tier translation table 514 based upon, at least in part, the type of action performed during online recovery. In one example, online recovery process 10 coordinates the changes to metadata pages resulting from a garbage collection operation with snapshot 516. For example, online recovery process 10 uses the amount of free space in the metadata tier to regulate the garbage collection operation including coordinating metadata changes from the metadata PLB tier 510 to snapshot 516. For example, a garbage collection operation scans PLBs to move the data in partially utilized PLBs to a new location. In this manner, online recovery process 10 recycles the PLBs and reuses them for new IO requests. With LSM mapping, the metadata will actually be kept in LSM metadata PLBs. In this example, online recovery is performed against snapshot 516 while the garbage collection operation is not running. However, current garbage collection is not aware that these PLBs are referenced by snapshot 516. For example, if the data in these PLBs are relocated, snapshot 516 loses track to these metadata pages in snapshot 516.

In some implementations, online recovery process 10 determines 414 an amount of free space in the metadata tier. For instance and as will be described in greater detail below, if there is enough free space in metadata PLB tier (e.g., above a predefined threshold), online recovery process 10 disables a garbage collection operation and enters an expansion-mode for metadata tiers (e.g., to provide an ample supply of free PLBs).

In some implementations, online recovery process 10 performs 416 an action on the metadata tier based upon, at least in part, the amount of free space in the metadata tier and a predefined free space threshold. For example, a predefined free space threshold may be defined by a user and/or automatically by online recovery process 10 to indicate when metadata PLB tier 510 has sufficient storage space that additional storage space is not required in the metadata PLB tier.

In some implementations and in response to determining that the amount of free space in the metadata tier is below the predefined free space threshold, online recovery process 10 identifies 418 a target metadata page for the action that is on the metadata tier and has a corresponding metadata page on the snapshot; and updates 420 the corresponding metadata page on the snapshot using the metadata page from the metadata tier. For example, when garbage collection is enabled after snapshot 516 is generated and is being used by online recovery, if a PLB (e.g., PLB 518) is referenced by a metadata page included in snapshot 516 (e.g., target metadata page 506), online recovery process 10 identifies 418 the target metadata page and updates 420 the corresponding metadata page. In some implementations, online recovery process 10 updates 420 the target metadata page by obtaining a write lock, moving the data location in PLB space for the target metadata page, and updating 420 the corresponding metadata page in snapshot 516. Accordingly, during the garbage collection flow, if garbage collection changes a PLB associated with a target metadata page that is also referenced by snapshot 516, the change is applied to both metadata tier 508 and snapshot 516.

In some implementations, performing 416 the action on the metadata tier includes, in response to determining that the amount of free space in the metadata tier is above the predefined free space threshold, pausing 422 the action on the metadata tier. For example, online recovery process 10 pauses garbage collection when there is sufficient free space in metadata PLB tier 510 (i.e., when the amount of free space is greater than the predefined free space threshold). In this manner, online recovery process 10 coordinates changes between metadata tier 508 and snapshot 516 by minimizing the downtime or pausing of other actions (e.g., garbage collection) during online recovery using snapshot 516.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a plurality of IO requests on a storage system;
generating a plurality of metadata pages associated with the processing of the plurality of IO requests;
generating a snapshot of the plurality of metadata pages; and
performing a plurality of actions on the snapshot without interfering with subsequent IO requests processed on the storage system.

2. The computer-implemented method of claim 1, wherein generating the plurality of metadata pages includes storing the plurality of metadata pages in a metadata tier.

3. The computer-implemented method of claim 2, wherein generating the snapshot of the plurality of metadata pages includes pausing changes to the metadata tier while the snapshot is generated.

4. The computer-implemented method of claim 2, wherein performing the plurality of actions on the snapshot includes performing online recovery of the metadata tier using the snapshot of the plurality of metadata pages.

5. The computer implemented method of claim 2, further comprising:
determining an amount of free space in the metadata tier.

6. The computer implemented method of claim 5, further comprising:
performing an action on the metadata tier based upon, at least in part, the amount of free space in the metadata tier and a predefined free space threshold.

7. The computer implemented method of claim 6, wherein performing the action on the metadata tier includes:
in response to determining that the amount of free space in the metadata tier is below the predefined free space threshold, identifying a target metadata page for the action that is on the metadata tier and has a corresponding metadata page on the snapshot; and
updating the corresponding metadata page on the snapshot using the metadata page from the metadata tier.

8. The computer implemented method of claim 6, wherein performing the action on the metadata tier includes, in response to determining that the amount of free space in the metadata tier is above the predefined free space threshold, pausing the action on the metadata tier.

9. A computer program product residing on a non-transitory computer readable medium having a plurality of instructions stored thereon which, when executed by a processor, cause the processor to perform operations comprising:
processing a plurality of IO requests on a storage system;
generating a plurality of metadata pages associated with the processing of the plurality of IO requests;
generating a snapshot of the plurality of metadata pages; and
performing a plurality of actions on the snapshot without interfering with subsequent IO requests processed on the storage system.

10. The computer program product of claim 9, wherein generating the plurality of metadata pages includes storing the plurality of metadata pages in a metadata tier.

11. The computer program product of claim 10, wherein generating the snapshot of the plurality of metadata pages includes pausing changes to the metadata tier while the snapshot is generated.

12. The computer program product of claim 10, wherein performing the plurality of actions on the snapshot includes performing online recovery of the metadata tier using the snapshot of the plurality of metadata pages.

13. The computer program product of claim 9, wherein the operations further comprise:
determining an amount of free space in the metadata tier.

14. The computer program product of claim 13, wherein the operations further comprise:
performing an action on the metadata tier based upon, at least in part, the amount of free space in the metadata tier and a predefined free space threshold.

15. A computing system comprising:
a memory; and
a processor configured to process a plurality of IO requests on a storage system, to generate a plurality of metadata pages associated with the processing of the plurality of IO requests, to generate a snapshot of the plurality of metadata pages, and to perform a plurality of actions on the snapshot without interfering with subsequent IO requests processed on the storage system.

16. The computing system of claim 15, wherein generating the plurality of metadata pages includes storing the plurality of metadata pages in a metadata tier.

17. The computing system of claim 16, wherein generating the snapshot of the plurality of metadata pages includes pausing changes to the metadata tier while the snapshot is generated.

18. The computing system of claim 16, wherein performing the plurality of actions on the snapshot includes performing online recovery of the metadata tier using the snapshot of the plurality of metadata pages.

19. The computing system of claim 16, wherein the processor is further configured to:
determine an amount of free space in the metadata tier.

20. The computing system of claim 15, wherein the processor is further configured to:
perform an action on the metadata tier based upon, at least in part, the amount of free space in the metadata tier and a predefined free space threshold.
